(19) United States
(12) Patent Application Publication
(10) Pub. No.: US 2026/0312727 A1
(43) Pub. Date: Oct. 8, 2026

(54) METHODS OF APPLYING CYCLIC-SHIFT-CODED MIMO OFDM SYSTEM TO SIMULTANEOUSLY PERFORM BEAM MANAGEMENT AND IMPROVE SENSING CAPABILITY IN INTEGRATED COMMUNICATION AND SENSING

(71) Applicant: MEDIATEK INC., Hsinchu City (TW)

(72) Inventors: Jiaying REN, San Jose, CA (US); Shiauhe Shawn TSAI, San Jose, CA (US)

(73) Assignee: MEDIATEK INC., Hsinchu City (TW)

(21) Appl. No.: 19/472,801

(22) PCT Filed: Dec. 12, 2024
(86) PCT No.: PCT/CN2024/138687

§ 371 Date: Oct. 6, 2025

Related U.S. Application Data
(60) Provisional application No. 63/608,891, filed on Dec. 12, 2023.

(51) Int. Cl. H04L 1/00; H04B 7/06; H04L 5/00

(52) U.S. Cl. CPC H04L 1/0061; H04B 7/06952; H04L 5/0005

(57) ABSTRACT

In an aspect of the disclosure, a method, a computer-readable medium, and an apparatus are provided. The method is a method for wireless communication of a wireless device. The wireless device generates a time-domain cyclic shift code set for a transmit antenna set. Each time-domain cyclic shift code in the set corresponds to one shift in a Doppler frequency domain. The wireless device applies the time-domain cyclic shift code set to transmit signals from the transmit antenna set to simultaneously: perform Doppler division multiplexing for transmit antenna port diversity and execute beam sweeping for beam management. The wireless device transmits the signals using the transmit antenna set.

### CROSS-REFERENCE TO RELATED APPLICATION(S)

This application claims the benefits of U.S. Provisional Application Ser. No. 63/608,891, entitled “METHOD OF APPLYING CYCLIC-SHIFT-CODED MIMO OFDM SYSTEM TO SIMULTANEOUSLY PERFORM BEAM MANAGEMENT AND IMPROVE SENSING CAPABILITY IN INTEGRATED COMMUNICATION AND SENSING” and filed on Dec. 12, 2023, which is expressly incorporated by reference herein in its entirety.

### TECHNICAL FIELD

The present disclosure relates generally to wireless communications, and more particularly, to the method of applying cyclic-shift-coded multiple-input and multiple-output (MIMO) Orthogonal Frequency Divisional Multiple (OFDM) system to simultaneously perform beam management and improve sensing capability in integrated communication and sensing (ISAC).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method is a method for wireless communication of a wireless device. The wireless device generates a time-domain cyclic shift code set for a transmit antenna set. Each time-domain cyclic shift code in the set corresponds to one shift in a Doppler frequency domain. The wireless device applies the time-domain cyclic shift code set to transmit signals from the transmit antenna set to simultaneously: perform Doppler division multiplexing for transmit antenna port diversity and execute beam sweeping for beam management. The wireless device transmits the signals using the transmit antenna set.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example of beam management.

FIG. 8 is a diagram illustrating an example architecture of an ISAC system.

FIG. 9 is a diagram illustrating an example result of simultaneously performing beam management and improving sensing capability in ISAC.

FIG. 10 is a flow chart of a process for simultaneously performing beam management and improving sensing capability in ISAC.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

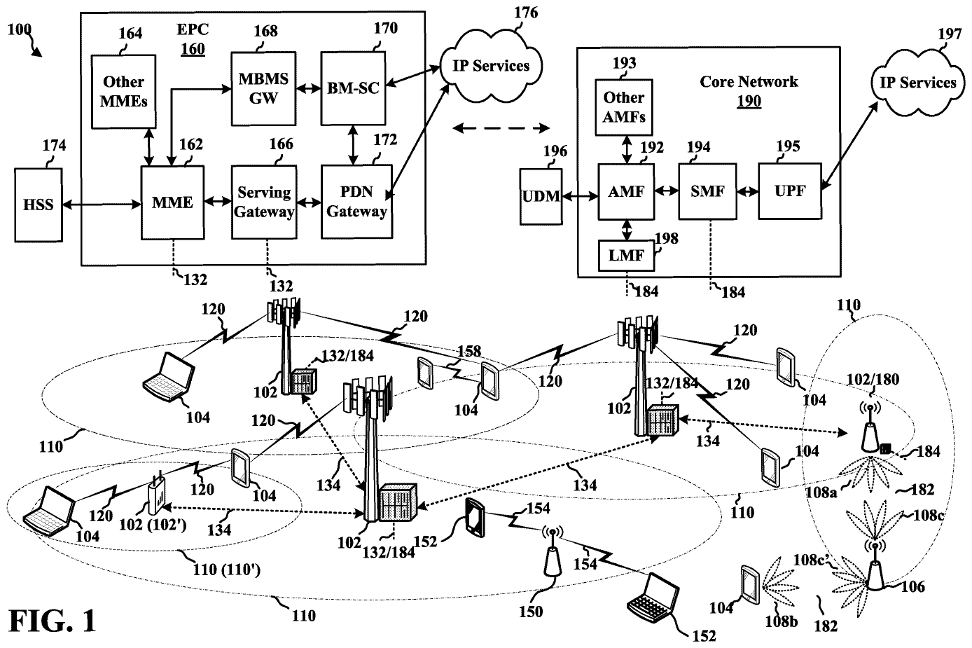

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

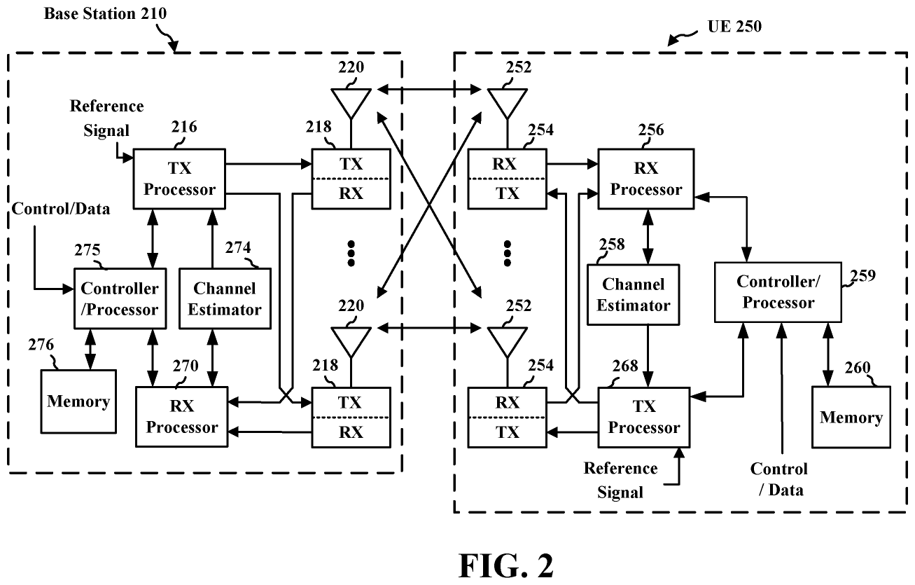

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

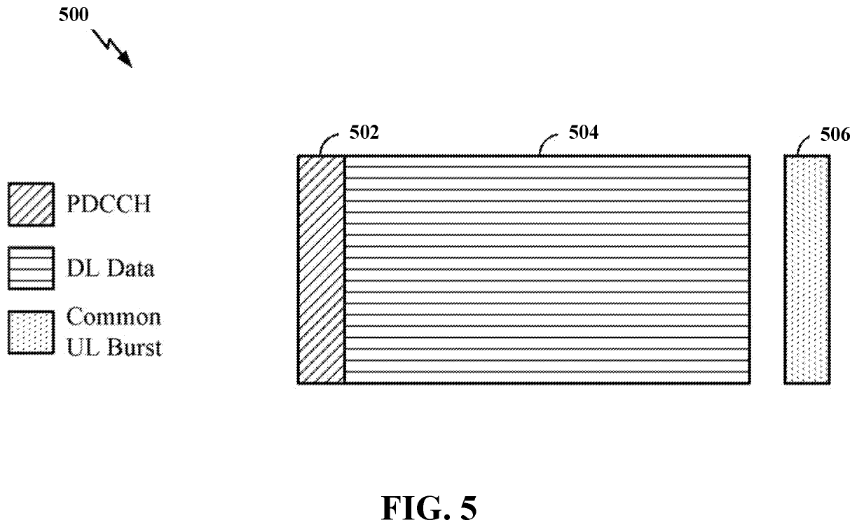

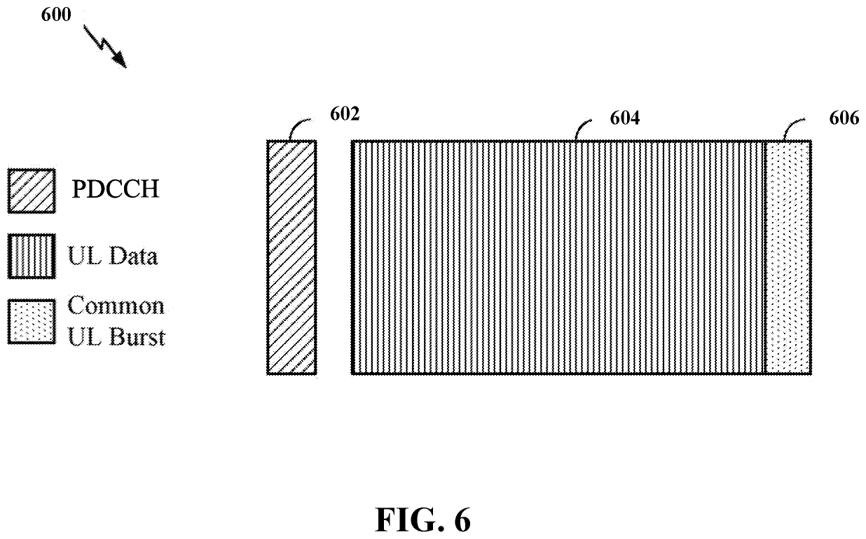

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

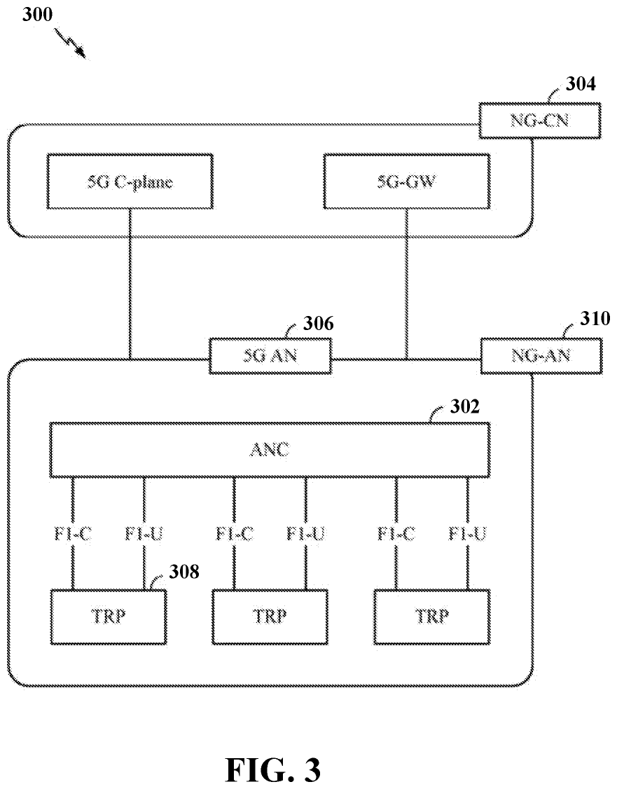

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

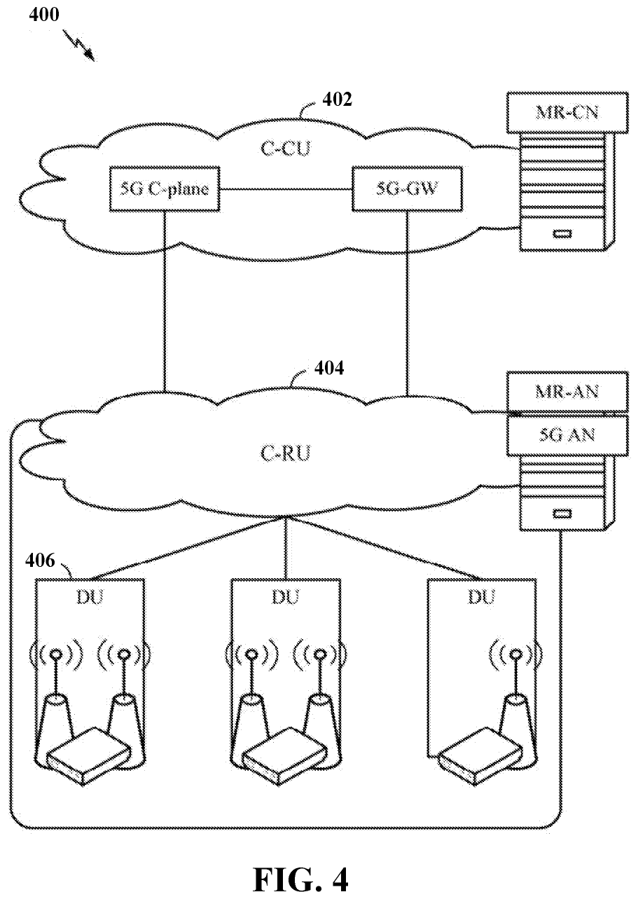

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

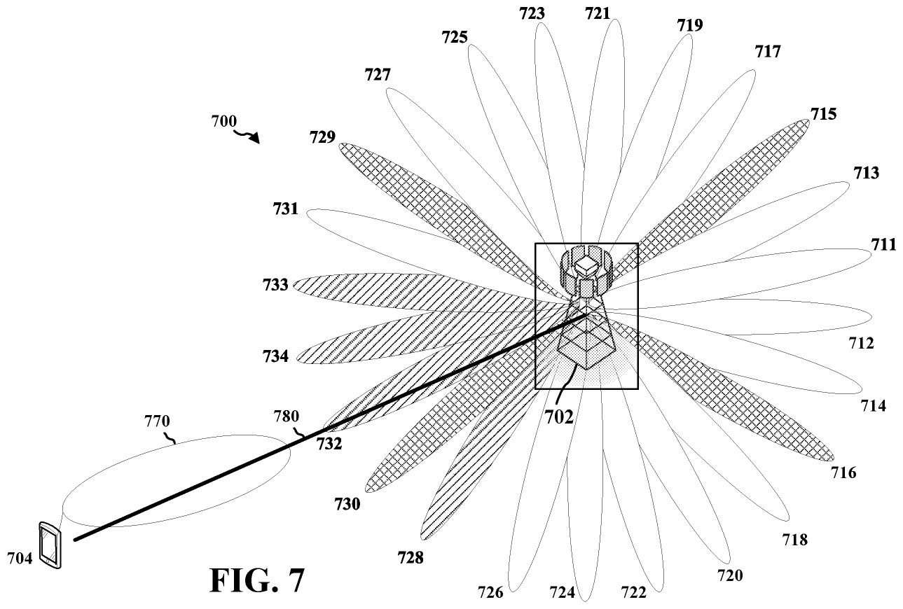

FIG. 7 is a diagram 700 illustrating an example of beam management. In this example, the base station 702 simultaneously transmits beams 711-734 in various directions via channel 780. After identifying incoming beams, the UE 704 can compute Layer 1 Reference Signal Received Power (L1-RSRP) for each beam. L1-RSRP is the average received power of the resource elements that carry the secondary synchronization signals or channel state information reference signals (CSI-RS).

In this example, the base station 702 is equipped with multiple antennas and is capable of simultaneously radiating 24 different beams 711-734 in various directions. The UE 704, which moves from time to time, may be equipped with its own antenna (or antennas) and periodically measures channel indicators such as RSRP from 4 beams (e.g. beams 715, 716, 729, and 730) selected from the 24 beams radiated by the base station 702. When the UE 704 initiates communication, it may select the UE 704 transmit or receive beam 770 that is likely to yield superior signal quality.

Beamforming, a technique for enhancing data rates and reliability in 5G and beyond wireless communication, especially in millimeter wave (mmWave) frequencies, enables a base station, such as the base station 702, to focus its signal transmission and reception toward a specific user equipment (UE), such as the UE 704. This targeted approach improves signal quality and reduces interference. To establish an optimal beam connection, the base station 702 and the UE 704 need to identify the best beams to transmit and receive data, a process known as beam management. Traditional beam management often involves exhaustive beam sweeping, where the base station 702 and the UE 704 systematically scan through all available beam directions to find the best one.

Channel State Information (CSI) significantly impacts the beamforming capability of transmitters and the decoding accuracy of receivers. On one hand, to accurately detect transmitted signals, receivers rely on channel estimation to compensate for received signals. On the other hand, base stations require channel estimation to implement beamforming, preprocessing the transmitted signals to align their spatial distribution characteristics with current channel conditions.

Integrated Sensing and Communication (ISAC) represents a transformative technology for 6G wireless systems that integrates communication and sensing functionalities into a unified framework. This integration aims to enhance spectrum utilization efficiency, reduce equipment costs, and drive technological innovations across multiple domains. In ISAC systems, sensing capabilities include target localization, imaging, detection, tracking, and identification, while communication capabilities focus on information transmission and aggregation.

The integration of sensing and communication in ISAC occurs at the physical layer, where sensors and communication devices are tightly coupled. This coupling enables devices to acquire environmental information through sensors and dynamically adjust communication protocols and parameters to optimize network performance and stability. Compared to traditional systems where sensing and communication operate independently, ISAC systems offer enhanced optimization capabilities for both sensing and communication signals, leading to improved reliability and real-time environmental sensing capabilities.

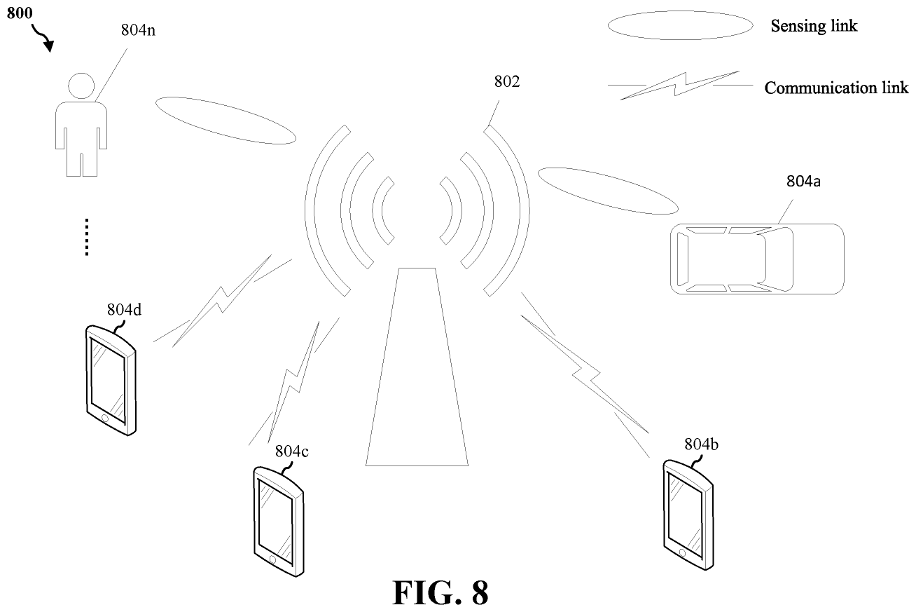

FIG. 8 is a diagram 800 illustrating an example architecture of an ISAC system. In the ISAC system 800, a multi-antenna ISAC node 802 at the base station side (e.g., base station 702) transmits unified OFDM signals to simultaneously estimate parameters of sensing targets and communicate with communication receivers located separately from the ISAC node 802.

The ISAC system 800 supports two types of objects at the user side. The first type includes sensing targets (also known as reflection targets), such as the objects 804a and 804n shown in FIG. 8. When radar waves reach these reflection targets, they are reflected back to the ISAC node 802, which then analyzes the reflected waves (echo signals) to determine various parameters including direction of arrival (DoA), range, and Doppler (velocity). These reflection targets typically do not require transmitting or receiving capabilities.

The second type includes communication receivers (data receiving objects), such as the objects 804b-c (e.g., UE 704) shown in FIG. 8. These receivers are equipped with communication receiving modules to process the communication data carried by the transmitted radar waves from the ISAC node 802. It is important to note that this classification serves primarily to aid understanding, as communication receivers can also function as reflection targets, effectively becoming reflection targets with data receiving capabilities.

The ISAC node 802 functions as a communication-sensing integration node, providing both sensing and communication services for terminals. The node can be implemented in either collocated or distributed antenna configurations, with the main difference being whether the azimuth angles of the transmitting and receiving ends are identical. Both configurations can achieve equivalent performance, though this description focuses on the collocated antenna configuration.

In the collocated antenna configuration, the transmitter (TX) and receiver (RX) of the ISAC node 802 occupy the same physical space but maintain physical separation to prevent signal interference. This arrangement allows information exchange between the transmitter and receiver, enabling the receiver to process radar data using knowledge of the transmitted data. The ISAC transmitter incorporates M TX antennas while the radar receiver uses L RX antennas, forming a 2D array that enables estimation of 3D position parameters and target velocities.

The system employs a time-domain cyclic shift code, corresponding to shifts in the Doppler domain, to achieve both port virtualization for enhanced sensing capabilities and beam sweeping for communication beam management. This approach allows the system to simultaneously perform Doppler division multiplexing for transmit antenna port diversity and execute beam sweeping patterns, effectively combining sensing and communication functionalities in a unified framework.

The collocated configuration supports the use of both pilot and payload signals for monostatic sensing, while the transmit antenna port diversity enhances the radar receive virtual array size, improving resolution and parameter identification capabilities. This architecture represents a significant advancement in integrated sensing and communication systems, offering improved performance in both sensing accuracy and communication efficiency.

In order to enhance the sensing capabilities and improve the resolution in integrated sensing and communication (ISAC) systems, it is beneficial to achieve larger virtual arrays by separating signals from different transmit antennas. One effective method to accomplish this is through the use of Doppler domain division multiplexing, which can be realized by applying time-domain cyclic shift codes.

The system implements Doppler domain division multiplexing by utilizing a cyclic-shift-coded Multiple-Input Multiple-Output (MIMO) approach. This method enables the creation of expanded virtual arrays for MIMO operations, thereby enhancing the system's sensing capabilities. The implementation employs a symbol-by-symbol cyclic shift code in the time domain, which corresponds to shifts in the Doppler domain. By applying this time-domain cyclic shift code, signals from different transmit antennas can be effectively separated in the Doppler domain, resulting in a larger virtual array.

Consider a MIMO system with M transmit antennas and L receive antennas. The transmitted baseband Cyclic Prefix-Orthogonal Frequency Division Multiplexing (CP-OFDM) signal from the mₜ-th transmit antenna during the q-th symbol period is given by:

$${s}_{{m}_{t}}^{q} ( t ) = {\sum }_{k = 1}^{K} {w}_{{m}_{t}}^{q} {s}^{q} ( k ) exp ( j 2 π ( k - 1 ) Δ ft ) ξ ( t - ( q - 1 ) {T}_{s} ) ,$$

where t∈[(q−1)Tₛ−T_{cp}, (q−1) Tₛ+T], and the window function ξ(t) is defined as:

$$ξ ( t ) = \{ \begin{matrix}1 , & t ∈ [ - {T}_{cp} , T ] , \\ 0 , & otherwise .\end{matrix}$$

In these expressions, s^{q}(k) represents the transmit data on the k-th subcarrier during the q-th symbol period. There are K orthogonal subcarriers in each symbol, and Q symbols are considered. The subcarrier spacing is

$$Δ f = \frac{1}{T} ,$$

where T is the duration of the OFDM symbol excluding the cyclic prefix. The total symbol duration is Tₛ=T+T_{cp}, with T_{cp} being the length of the cyclic prefix.

To achieve Doppler domain cyclic shifting for each transmit antenna, phase rotations are applied in the slow-time domain, that is, across the symbol index q. Applying a phase rotation in the slow-time domain is equivalent to applying a cyclic shift in the Doppler-frequency domain. The time-domain cyclic shift code used for generating data fed to different transmit antennas is given by:

$${w}_{{m}_{t}}^{q} = exp ( j 2 π \frac{{I}_{{m}_{t}}}{M} ( q - 1 ) ) ,$$

where I=[I₁, I₂, . . . , I_{M}] is the cyclic shift index vector, and each Iₘ_{ₜ} is a permutation of the set {0, 1, . . . , M−1}. This assignment ensures that each transmit antenna is associated with a unique cyclic shift index.

By applying this time-domain cyclic shift code, the signals from different transmit antennas are effectively shifted in the Doppler domain. When the signals are received and processed, this shift enables the separation of signals from different transmit antennas based on their Doppler frequencies. Specifically, the phase rotation introduced by the cyclic shift code causes the desired signal components to align at specific Doppler frequencies, while interference from other transmit antennas appears at other Doppler frequencies.

Consider the locations of the transmit and receive antennas. The mₜ-th transmit antenna (TX) is located at (0,0, (mₜ−1)d), where d is the antenna spacing along the z-axis. The mᵣ-th receive antenna (RX) is located at

$$( {x}_{{m}_{r}}^{R} , 0 , {y}_{{m}_{r}}^{R} ) .$$

Assume there are N targets in the environment. For the n-th target, let ξₙ, fₙ, θₙ, ψₙ, and Äₙ denote the time delay, Doppler frequency, azimuth angle, elevation angle, and complex gain, respectively.

After downconversion, the baseband echo signal received by the radar receiver is expressed as:

$$\tilde{y} ( t ) = \sqrt{M L} {\sum }_{n = 1}^{N} {\sum }_{q = 1}^{Q} {\tilde{A}}_{n} exp ( j 2 π {f}_{n} {T}_{s} ( q - 1 ) ) \times {a}^{R} ( {θ}_{n} , {ψ}_{n} ) {a}^{T} ( {ψ}_{n} ) {x}^{q} ( t - {τ}_{n} ) ,$$

where x^{q}(t−τₙ) is the transmitted signal delayed by τₙ, and Q is the total number of OFDM symbols.

The vector a^{R}(θₙ, ψₙ) represents the steering vector of the receive antenna array, given by:

$${a}^{R} ( {θ}_{n} , {ψ}_{n} ) = {\frac{1}{\sqrt{L}} [ \begin{matrix}exp ( - j \frac{2 π}{λ} ( {x}_{1}^{R} cos {θ}_{n} cos {ψ}_{n} + {z}_{1}^{R} sin {ψ}_{n} ) ) , \\ ⋯ , \\ exp ( - j \frac{2 π}{λ} ( {x}_{L}^{R} cos {θ}_{n} cos {ψ}_{n} + {z}_{L}^{R} sin {ψ}_{n} ) ) ,\end{matrix} ]}^{T} ,$$

where λ is the wavelength, and L is the number of receive antennas. Similarly, a^{T}(ψₙ) is the steering vector of the transmit antenna array:

$${a}^{T} ( {ψ}_{n} ) = \frac{1}{\sqrt{M}} [ 1 , exp ( - j \frac{2 π}{λ} d sin {ψ}_{n} ) , … , exp ( - j \frac{2 π}{λ} d ( M - 1 ) sin {ψ}_{n} ) ] ,$$

where M is the number of transmit antennas.

Assuming that the time delays satisfy τₙ≤T_{cp} for all n, where T_{cp} is the cyclic prefix duration, signal processing steps are performed that include cyclic prefix removal, OFDM demodulation, and the removal of payload data randomness.

After the cyclic prefix is removed and the OFDM demodulation is performed, the preprocessed echo signal for the q-th symbol and k-th subcarrier is:

$${\breve{y}}^{q} ( k ) = \sqrt{L} {\sum }_{n = 1}^{N} {A}_{n} exp ( j 2 π {f}_{n} {T}_{s} ( q - 1 ) ) \times exp ( - j 2 π ( k - 1 ) Δ f {τ}_{n} ) {a}^{R} ( {θ}_{n} , {ψ}_{n} ) \times {\sum }_{{m}_{t} = 1}^{M} exp ( - j \frac{2 π}{λ} ( {m}_{t} - 1 ) d sin {ψ}_{n} ) {w}_{{m}_{t}}^{q} ,$$

where Aₙ=Ãₙ/\sqrt{M}, and the term

$${w}_{{m}_{t}}^{q}$$

is the cyclic shift code applied to the mₜ-th transmit antenna at the q-th symbol.

To recover the desired signal from the mₜ-th transmit antenna and the mᵣ-th receive antenna, the received signal is multiplied by the complex conjugate of the cyclic shift code corresponding to the mₜ-th transmit antenna:

$${z}_{{m}_{t} , {m}_{r}}^{q} ( k ) = conj ( {w}_{{m}_{t}}^{q} ) {\breve{y}}_{{m}_{r}}^{q} ( k ) ,$$

where

$${\breve{y}}_{{m}_{r}}^{q} ( k )$$

is the element of [symbol] ^{q}(k) corresponding to the mᵣ-th receive antenna, and conj(⋅) denotes the complex conjugate operation.

The signal

$${z}_{{m}_{t} , {m}_{r}}^{q} ( k )$$

includes two components: the desired echo from the mₜ-th transmit antenna to the mᵣ-th receive antenna, and interference from other transmit antennas.

$${z}_{{m}_{t} , {m}_{r}}^{q} ( k )$$

may be expressed as:

$${z}_{{m}_{t} , {m}_{r}}^{q} ( k ) = {z}_{{m}_{t} , {m}_{r}}^{( q , desired )} ( k ) + {z}_{{m}_{t} , {m}_{r}}^{( q , interference )} ( k ) ,$$

where the desired component is:

$${z}_{{m}_{t} , {m}_{r}}^{( q , desired )} ( k ) = {\sum }_{n = 1}^{N} {A}_{n} exp ( - j \frac{2 π}{λ} ( {x}_{{m}_{r}}^{R} cos {θ}_{n} cos {ψ}_{n} + {y}_{{m}_{r}}^{R} sin {ψ}_{n} ) ) exp ( - j 2 π ( k - 1 ) Δ f {τ}_{n} ) exp ( - j \frac{2 π}{λ} ( {m}_{t} - 1 ) d sin {ψ}_{n} ) exp ( j 2 π {f}_{n} {T}_{s} ( q - 1 ) ) ,$$

and the interference component is:

$${z}_{{m}_{t} , {m}_{r}}^{( q , interference )} ( k ) {\sum }_{n = 1}^{N} {A}_{n} exp ( - j \frac{2 π}{λ} ( {x}_{{m}_{r}}^{R} cos {θ}_{n} cos {ψ}_{n} + {y}_{{m}_{r}}^{R} sin {ψ}_{n} ) ) exp ( - j 2 π ( k - 1 ) Δ f {τ}_{n} ) \times {\sum }_{\begin{matrix}{{m}_{t}}^{′} = 1 \\ {{m}_{t}}^{′} \neq {m}_{t}\end{matrix}}^{M} exp ( - j \frac{2 π}{λ} ( {{m}_{t}}^{′} - 1 ) d sin {ψ}_{n} ) \times exp ( j 2 π [ {f}_{n} {T}_{s} + \frac{{I}_{{{m}_{t}}^{′}} - {I}_{{m}_{t}}}{M} ] ( q - 1 ) ) .$$

In the desired component, the signal corresponds to the propagation path from the mₜ-th transmit antenna to the mᵣ-th receive antenna via the n-th target. The exponential terms represent the effects of spatial steering, time delay, and Doppler shift.

In the interference component, the signals from other transmit antennas

$$( {{m}_{t}}^{′} \neq {m}_{t} )$$

contribute to interference. The term

$$\frac{{I}_{{{m}_{t}}^{′}} - {I}_{{m}_{t}}}{MTs}$$

introduces an additional frequency shift due to the difference in cyclic shift indices between transmit antennas.

Since the slow-time cyclic shift code provides Doppler division multiplexing, the interference from other transmit antennas can be suppressed by exploiting the differences in Doppler frequencies. Specifically, a slow-time Fourier Transform (FFT) is performed across the symbol index q for each k and antenna pair (mₜ, mᵣ).

Due to the cyclic shifts applied, the desired signal is centered around the Doppler frequency fₙ, while the interference signals are shifted by additional Doppler frequencies determined by the differences in cyclic shift indices. The interference signals appear at Doppler frequencies offset by

$$Δ {f}_{interf} = \frac{{I}_{{{m}_{t}}^{′}} - {I}_{{m}_{t}}}{MTs}$$

from the desired Doppler frequency fₙ.

By retaining only the FFT results within the Doppler frequency range:

$$f ∈ [ - \frac{1}{2 MTs} , \frac{1}{2 MTs} ] ,$$

and setting the FFT results outside this range to zero, the interference from other transmit antennas may effectively suppressed. This process filters out the interference components which are shifted outside the desired Doppler frequency range due to the cyclic shifts.

By utilizing Doppler domain filtering after applying the cyclic shift codes, port virtualization may be achieved. This process effectively separates the signals from different transmit antennas into distinct Doppler frequency bins, allowing them to be treated as if they were transmitted from separate virtual antennas. Consequently, a larger virtual array may be obtained. This enhances the spatial resolution and parameter estimation capabilities of the radar system.

The enlarged virtual array enables the system to distinguish between multiple closely spaced targets and improves the accuracy of estimating parameters such as direction of arrival, range, and velocity. This is particularly beneficial in environments with multiple targets or in applications requiring high-resolution sensing.
The time-domain cyclic shift code, while enabling Doppler domain division multiplexing for sensing capabilities, also influences the communication performance of the system. This influence manifests through the angular domain channel pattern for communication receivers. Consider a uniform linear transmit array that serves both sensing and communication purposes, along with a communication receiver equipped with a receive antenna. For a transmit angle of departure (AOD) θ, the angular domain channel pattern can be expressed as:

$${H}_{θ} ( q ) = {\sum }_{{m}_{t}} exp ( - j \frac{2 π}{λ} ( {m}_{c} - 1 ) d sin θ ) exp ( j 2 π \frac{{l}_{{m}_{t}}}{M} ( q - 1 ) ) ,$$

where the second exponential term represents the cyclic shift code

$${w}_{{m}_{t}}^{q} .$$

This channel pattern exhibits periodicity with respect to the symbol index q, such that:

$${H}_{θ} ( q ) = {H}_{θ} ( q + M ) .$$

When the cyclic shift indices are assigned as Iₘ_{ₜ}=mₜ−1, the system achieves periodic spatial diversity with a period of M symbols. This assignment creates a progressive phase rotation across the transmit antennas. For example, in a system with four transmit antennas, the first antenna transmits symbols without phase rotation (0 degrees), the second antenna applies a ¼ phase rotation, the third antenna applies a ½ phase rotation, and the fourth antenna applies a ¾ phase rotation.
With this progressive assignment of cyclic shift indices, the angular domain channel pattern can be expressed in closed form as:

$${H}_{θ} ( q ) = \frac{1 - exp ( - j π M ( sin θ - \frac{2 mod ( q - 1 , M )}{M} ) )}{1 - exp ( - j π ( sin θ - \frac{2 mod ( q - 1 , M )}{M} ) )} .$$

A notable characteristic of this pattern is that the mainlobe of the beam in the q-th symbol appears at angles satisfying:

$$sin θ = \frac{2 mod ( q - 1 , M )}{M} + 2 i , i ∈ \{ i ∈ ℕ : - 1 \leq \frac{2 mod ( q - 1 , M )}{M} + 2 i \leq 1 \} .$$

This relationship indicates that the transmitter performs periodic beam sweeping using the slow-time cyclic shift code. For a system with M transmit antennas, the first symbol and the (M+1)-th symbol point in the same direction, while symbols 1 through M collectively perform a complete beam sweep across the spatial domain.

This beam sweeping behavior makes the system particularly suitable for beam management in communication systems. The ISAC node 802 can utilize this inherent property to perform beam sweeping operations while simultaneously maintaining its sensing capabilities through Doppler domain division multiplexing. This dual functionality allows the system to efficiently manage both communication and sensing tasks without requiring separate hardware or time-multiplexed operations.

The periodic nature of the beam pattern provides a systematic method for scanning the entire spatial domain, which aids in identifying and tracking communication receivers such as the objects 804b-c shown in FIG. 8. This capability becomes particularly valuable in scenarios where the communication system needs to establish and maintain connections with multiple users while simultaneously performing sensing operations for targets such as the objects 804a and 804n.

The ISAC system may be improved by introducing an additional phase term per transmit antenna. This modification allows precise control over the initial beam direction, facilitating periodic beam sweeping for improved communication beam management while maintaining the enhanced sensing capabilities provided by the Doppler domain division multiplexing.

To steer the beam towards a desired initial angle θ₀, an additional phase corresponding to the single Uniform Linear Array (ULA) wavefront is applied to each transmit antenna. The modified slow-time cyclic shift code for the mₜ-th transmit antenna at the q-th symbol becomes:

$${w}_{{m}_{t}}^{q} = exp ( j 2 π \frac{{I}_{{m}_{t}}}{M} ( q - 1 ) ) exp ( j \frac{2 π}{λ} ( {m}_{t} - 1 ) d sin {θ}_{0} ) ,$$

where:
Iₘ_{ₜ} is the cyclic shift index for the mₜ-th antenna, with Iₘ_{ₜ}=mₜ−1,
M is the total number of transmit antennas,
(mₜ−1)d represents the position of the mₜ-th antenna along the array,
λ is the wavelength,
θ₀ is the desired initial steering angle.

This additional phase term

$$exp ( j \frac{2 π}{λ} ( {m}_{t} - 1 ) d sin {θ}_{0} )$$

towards θ₀, effectively adjusting the initial beam direction.

The angular domain channel matrix H_{θ}(q) for a receiver at angle θ can be expressed using the modified shift code:

$$\begin{matrix}{H}_{θ} ( q ) = {\sum }_{{m}_{t} = 1}^{M} exp ( - j \frac{2 π}{λ} ( {m}_{t} - 1 ) d sin θ ) {w}_{{m}_{t}}^{q} \\ = {\sum }_{{m}_{t} = 1}^{M} exp ( - j π ( {m}_{t} - 1 ) ( sin θ - sin {θ}_{0} - \frac{2 mod ( q - 1 , M )}{M} ) ) ,\end{matrix}$$

where Iₘ_{ₜ}=mₜ−1.

This summation forms a geometric series that can be evaluated in closed form:

$${H}_{θ} ( q ) = \frac{1 - exp ( - j π ( {m}_{t} - 1 ) ( sin θ - sin {θ}_{0} - \frac{2 mod ( q - 1 , M )}{M} ) )}{1 - exp ( - j π ( {m}_{t} - 1 ) ( sin θ - sin {θ}_{0} - \frac{2 mod ( q - 1 , M )}{M} ) )} .$$

The numerator and denominator represent the sum of a finite geometric series, capturing the cumulative effect of the phased array.

The mainlobe of the beam in the q-th symbol is directed towards angles where the denominator approaches zero, which occurs at:

$$sin θ = sin {θ}_{0} + \frac{2 mod ( q - 1 , M )}{M} + 2 i , i ∈ ℤ , - 1 \leq sin θ \leq 1.$$

Here, mod(q−1, M) ensures that the beam direction cycles every M symbols, resulting in a periodic beam sweeping pattern across different spatial angles.

For instance, with M=4 transmit antennas and initial angle θ₀=0°, the beam directions for symbols q=1 to 4 are calculated as:

$$sin {θ}_{1} = sin ° + \frac{2 \times 0}{4} = 0 , \qquad {θ}_{1} = 0 ° ,$$

$$sin {θ}_{2} = sin ° + \frac{2 \times 1}{4} = 0.5 , \qquad {θ}_{2} = 30 ° ,$$

$$sin {θ}_{3} = sin ° + \frac{2 \times 2}{4} = 1 , \qquad {θ}_{3} = 90 ° ,$$

$$sin {θ}_{4} = sin ° + \frac{2 \times 3}{4} = 1.5 , \qquad {θ}_{4} ( out of range ) .$$

Since sin θ must be between −1 and 1, the value sin θ₄=1.5 exceeds the physical range. This condition results in the beam wrapping around, effectively pointing towards θ₄=−30°, due to the periodic nature of the sine function.

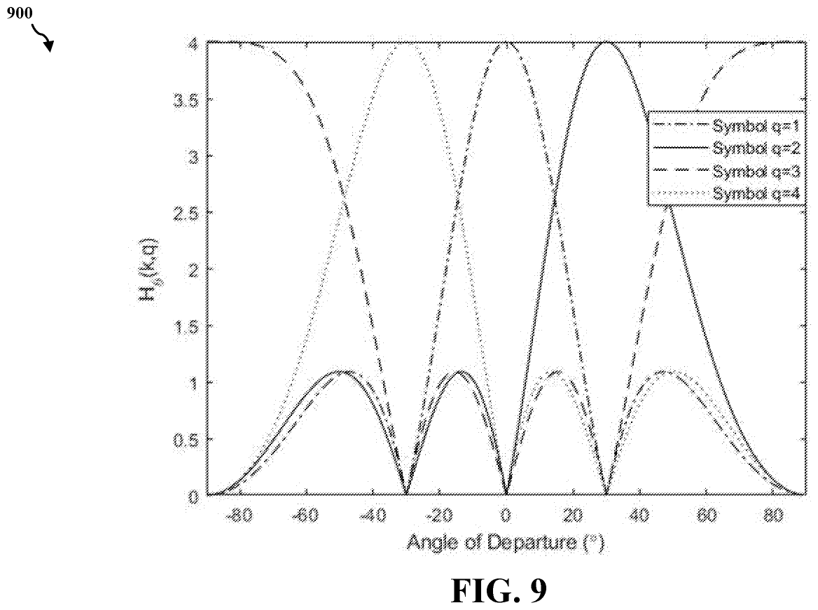

FIG. 9 is a diagram 900 illustrating a beam sweeping pattern for the 4TX example with θ₀=0°. In this example, the beam directions for the four symbols are at 0°, 30°, 90°, and −30°, respectively. This periodic beam sweeping enables the transmitter to cover multiple spatial directions over successive symbols, enhancing the ability to communicate with receivers located at different angles.

The concept of beam sweeping with slow-time cyclic-shift-coded MIMO can be extended to configurations involving multiple ULAs. Consider a system where M=J\tilde{M} transmit antennas form J ULAs, each with \tilde{M} antennas. This arrangement allows the system to serve multiple communication directions simultaneously.

For the j-th ULA, the cyclic shift index vector is defined as:

$${I}^{j} = [ j - 1 , J + j - 1 , 2 J + j - 1 , … , ( M - 1 ) J + j - 1 ] ,$$

where j=1, 2, . . . , J, and the indices are a permutation of the set to ensure unique cyclic shifts within each ULA.

The angular channel matrix for the j-th ULA is then:

$${H}_{θ}^{j} ( q ) = {e}^{j 2 π \frac{j - 1}{M} ( q - 1 )} {H}_{θ} ( q ) ,$$

where H_{θ}(q) is the base angular channel matrix as previously defined. The exponential term

$${e}^{j 2 π \frac{j - 1}{M} ( q - 1 )}$$

introduces a phase shift specific to the ULA group, effectively separating the beams in the angular domain.

Since the modulus of the exponential term is one, it does not alter the magnitude of the channel response but provides a distinct phase offset for each ULA. This property allows each ULA to perform independent beam sweeping without interfering with the others, enabling the system to serve different communication directions simultaneously.

By designing the precoder (the additional per-antenna phase) for each ULA individually, using the same methodology as for a single ULA, the system can effectively manage multiple beams. This approach enhances the flexibility and scalability of the system.

The beam sweeping enabled by the slow-time cyclic-shift-coded MIMO system can be implemented in both base stations and user equipment (UE) equipped with multiple transmit antennas. The described technique is not limited to any specific network entity, allowing for versatile deployment scenarios.

In practical applications, the number of transmit antennas M and the initial beam direction θ₀ can be adapted based on the system requirements and the spatial distribution of users. The periodic beam sweeping ensures that over time, the transmitter can cover the entire desired angular sector.

By transmitting the same information over M symbols, the system maintains consistent communication with users in different directions, while the Doppler division multiplexing provided by the cyclic shift codes enhances the sensing capabilities through antenna port virtualization.

The incorporation of an additional per-antenna phase in the slow-time cyclic-shift-coded MIMO system enhances the beamforming capabilities, enabling periodic beam sweeping without compromising the system's sensing performance. This advancement allows for efficient beam management in communication while utilizing the same signal and antenna resources for sensing, achieving a high degree of integration in ISAC systems. By extending the methodology to multiple ULAs, the system can scale to serve diverse communication directions and meet the demands of complex wireless environments.

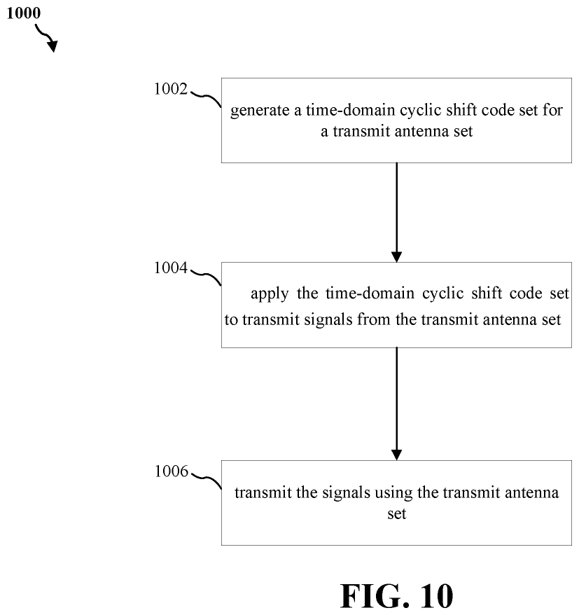

FIG. 10 is a flow chart 1000 of a process for simultaneously performing beam management and improving sensing capability in ISAC. This process involves a method for wireless communication of a wireless device such as the objects 804b-c.

At block 1002, the wireless device generates a time-domain cyclic shift code set for a transmit antenna set. Each time-domain cyclic shift code in the set corresponds to one shift in a Doppler frequency domain. For example, the time-domain cyclic shift code set may include a plurality of codewords, each codeword corresponding to a shift.

At block 1004, the wireless device applies the time-domain cyclic shift code set to transmit signals from the transmit antenna set to simultaneously: perform Doppler division multiplexing for transmit antenna port diversity; and execute beam sweeping for beam management.

At block 1006, the wireless device transmits the signals using the transmit antenna set.

In some embodiments, generating the time-domain cyclic shift code set may include: assigning cyclic shift indices to antennas in the transmit antenna set according to:

$${w}_{{m}_{t}}^{q} = exp ( j 2 π \frac{{I}_{{m}_{t}}}{M} ( q - 1 ) ) ,$$

where

$${w}_{{m}_{t}}^{q}$$

shift code for an mₜ-th antenna at a q-th symbol, Iₘ_{ₜ} is a cyclic shift index, and M is a number of antennas in the transmit antenna set.

In some embodiments, the cyclic shift indices Iₘ_{ₜ} may include a permutation of integers from 0 to M−1.

In some embodiments, Iₘ_{ₜ}=mₜ−1 for each mₜ-th antenna in the transmit antenna set.

In some embodiments, executing the beam sweeping may include: sweeping a beam through different spatial directions over M successive symbols, where M is a number of antennas in the transmit antenna set.

In some embodiments, the process may further include: applying an additional phase term to the time-domain cyclic shift code set to steer an initial beam direction to a predetermined angle θ₀.

In some embodiments, the additional phase term may be given by:

$$exp ( j \frac{2 π}{λ} ( {m}_{t} - 1 ) d sin {θ}_{0} ) ,$$

where λ is a wavelength, d is an antenna spacing, and mₜ is an antenna index.

In some embodiments, performing the Doppler division multiplexing may include:
filtering received signals in a Doppler frequency range of

$$[ - \frac{1}{2 M {T}_{s}} , \frac{1}{2 M {T}_{s}} ] ,$$

where M is a number of antennas in the transmit antenna set and Tₛ is a symbol duration.

In some embodiments, the transmit signals may include Cyclic Prefix-Orthogonal Frequency Division Multiplexing (CP-OFDM) signals.

In some embodiments, the process may further include: transmitting identical information over M consecutive symbols while performing the beam sweeping, where M is a number of antennas in the transmit antenna set.

In some embodiments, the transmit antenna set may include multiple uniform linear arrays (ULAs), and generating the time-domain cyclic shift code set may include: assigning different cyclic shift index vectors to different ULAs.

In some embodiments, for a j-th ULA having M antennas, the cyclic shift index vector may include:

$$[ j - 1 , J + j - 1 , 2 J + j - 1 , … , ( \tilde{M} - 1 ) J + j - 1 ] ,$$

where J is a total number of ULAs, \tilde{M} is a positive integer, and J·\tilde{M}=M.

In some embodiments, the process may further include: processing received signals by: applying a complex conjugate of the time-domain cyclic shift code set; and performing Doppler domain filtering to suppress interference from other transmit antennas.

In some embodiments, the beam sweeping may provide beam directions at angles satisfying:

$$sin θ = sin {θ}_{0} + \frac{2 mod ( q - 1 , M )}{M} + 2 i ,$$

where θ₀ is an initial beam direction, q is a symbol index, M is a number of antennas, and i is an integer satisfying −1≤sin θ≤1.

In some embodiments, the beam sweeping may operate in one of the following modes: a single shot, multiple shots, periodic, or any combination thereof.

In some embodiments, the wireless device may include a base station or user equipment in an integrated sensing and communication (ISAC) system, and the transmit signals may be used for both sensing and communication.

Once the subset of beams meeting the performance metrics is determined, the UE 704 reports these measurement results according to the received beam report configuration. This may involve reporting the predicted best beams, their corresponding RSRP values, or other specified metrics. The specific order or hierarchy of blocks in the processes/flowcharts disclosed is an illustration of exemplary approaches. Based upon design preferences, the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for wireless communication of a wireless device, comprising:
generating a time-domain cyclic shift code set for a transmit antenna set, wherein each time-domain cyclic shift code in the set corresponds to one shift in a Doppler frequency domain;
applying the time-domain cyclic shift code set to transmit signals from the transmit antenna set to simultaneously:
perform Doppler division multiplexing for transmit antenna port diversity; and
execute beam sweeping for beam management; and
transmitting the signals using the transmit antenna set.

2. The method of claim 1, wherein the generating the time-domain cyclic shift code set comprises:
assigning cyclic shift indices to antennas in the transmit antenna set according to:
$${w}_{{m}_{t}}^{q} = exp ( j 2 π \frac{{I}_{{m}_{t}}}{M} ( q - 1 ) ) ,$$
where
$${w}_{{m}_{t}}^{q}$$
is a time-domain cyclic shift code for an mₜ-th antenna at a q-th symbol Iₘ_{ₜ} is a cyclic shift index, and M is a number of antennas in the transmit antenna set.

3. The method of claim 2, wherein the cyclic shift indices Iₘ_{ₜ} comprise a permutation of integers from 0 to M−1.

4. The method of claim 2, wherein Iₘ_{ₜ}=mₜ−1 for each mₜ-th antenna in the transmit antenna set.

5. The method of claim 1, wherein executing the beam sweeping comprises:
sweeping a beam through different spatial directions over M successive symbols, where M is a number of antennas in the transmit antenna set.

6. The method of claim 1, further comprising:
applying an additional phase term to the time-domain cyclic shift code set to steer an initial beam direction to a predetermined angle θ₀.

7. The method of claim 6, wherein the additional phase term is given by:
$$exp ( j \frac{2 π}{λ} ( {m}_{t} - 1 ) d sin {θ}_{0} ) ,$$
where λ is a wavelength, d is an antenna spacing, and mₜ is an antenna index.

8. The method of claim 1, wherein performing the Doppler division multiplexing comprises:
filtering received signals in a Doppler frequency range of
$$[ - \frac{1}{2 {MT}_{s}} , \frac{1}{2 {MT}_{s}} ] ,$$
where M is a number of antennas in the transmit antenna set and Tₛ is a symbol duration.

9. The method of claim 1, wherein the transmit signals comprise Cyclic Prefix-Orthogonal Frequency Division Multiplexing (CP-OFDM) signals.

10. The method of claim 1, further comprising:
transmitting identical information over M consecutive symbols while performing the beam sweeping, where M is a number of antennas in the transmit antenna set.

11. The method of claim 1, wherein the transmit antenna set comprises multiple uniform linear arrays (ULAs), and wherein generating the time-domain cyclic shift code set comprises:
assigning different cyclic shift index vectors to different ULAs.

12. The method of claim 11, wherein for a j-th ULA having M antennas, the cyclic shift index vector comprises:
$$[ j - 1 , J + j - 1 , 2 J + j - 1 , … , ( \tilde{M} - 1 ) J + j - 1 ] ,$$
where J is a total number of ULAs, \tilde{M} is a positive integer, and J·\tilde{M}=M.

13. The method of claim 1, further comprising:
processing received signals by:
applying a complex conjugate of the time-domain cyclic shift code set; and
performing Doppler domain filtering to suppress interference from other transmit antennas.

14. The method of claim 1, wherein the beam sweeping provides beam directions at angles satisfying:
$$sin θ = sin {θ}_{0} + \frac{2 mod ( q - 1 , M )}{M} + 2 i ,$$
where θ₀ is an initial beam direction, q is a symbol index, M is a number of antennas, and i is an integer satisfying −1≤sin θ≤1.

15. The method of claim 1, wherein the beam sweeping operates in one of the following modes: a single shot, multiple shots, periodic, or any combination thereof.

16. The method of claim 1, wherein the wireless device comprises a base station or user equipment in an integrated sensing and communication (ISAC) system, and wherein the transmit signals are used for both sensing and communication.

17. An apparatus for wireless communication, the apparatus being a wireless device, comprising:
a memory; and
at least one processor coupled to the memory and configured to:
generate a time-domain cyclic shift code set for a transmit antenna set, wherein each time-domain cyclic shift code in the set corresponds to one shift in a Doppler frequency domain;
apply the time-domain cyclic shift code set to transmit signals from the transmit antenna set to simultaneously:
perform Doppler division multiplexing for transmit antenna port diversity; and
execute beam sweeping for beam management; and
transmit the signals using the transmit antenna set.

18. The apparatus of claim 17, wherein to generate the time-domain cyclic shift code set, the processor is further configured to:
assign cyclic shift indices to antennas in the transmit antenna set according to:
$${w}_{{m}_{t}}^{q} = exp ( j 2 π \frac{{I}_{{m}_{t}}}{M} ( q - 1 ) ) ,$$
where
$${w}_{{m}_{t}}^{q}$$
is a time-domain cyclic shift code for an mₜ-th antenna at a q-th symbol, Iₘ_{ₜ} is a cyclic shift index, and M is a number of antennas in the transmit antenna set.

19. A computer-readable medium storing computer executable code for wireless communication of a wireless device, comprising code to:
generate a time-domain cyclic shift code set for a transmit antenna set, wherein each time-domain cyclic shift code in the set corresponds to one shift in a Doppler frequency domain;
apply the time-domain cyclic shift code set to transmit signals from the transmit antenna set to simultaneously:
perform Doppler division multiplexing for transmit antenna port diversity; and
execute beam sweeping for beam management; and
transmit the signals using the transmit antenna set.

20. The computer-readable medium of claim 19, wherein to generate the time-domain cyclic shift code set, the code is further configured to:
assign cyclic shift indices to antennas in the transmit antenna set according to:
$${w}_{{m}_{t}}^{q} = exp ( j 2 π \frac{{I}_{{m}_{t}}}{M} ( q - 1 ) ) ,$$
where
$${w}_{{m}_{t}}^{q}$$
is a time-domain cyclic shift code for an mₜ-th antenna at a q-th symbol, Iₘ_{ₜ} is a cyclic shift index, and M is a number of antennas in the transmit antenna set.
